(19) United States
(12) Patent Application Publication
(10) Pub. No.: US 2004/0225806 A1
(43) Pub. Date: Nov. 11, 2004

(54) Network communication apparatus and bridge apparatus

(76) Inventors: Noriaki Emura, Yokohama-shi (JP); Takashi Kokubo, Yokohama-shi (JP)

Correspondence Address: PILLSBURY WINTHROP, LLP, P.O. BOX 10500, MCLEAN, VA, 22102, US

(21) Appl. No.: 09/776,766

(22) Filed: Feb. 6, 2001

(30) Foreign Application Priority Data
Sep. 29, 2000 (JP) 2000-300444

(51) Int. Cl. G06F 13/38; G06F 13/40

(52) U.S. Cl. 710/305

(57) ABSTRACT

A network communication apparatus has an interface for allowing digital data to be transferred to a node apparatus on a second network via a bus bridge apparatus through which a first network having the network communication apparatus connected thereto and the second network are connected, and a bus reset processing section for, when bus resetting occurs on the first network, generating a notify signal for notifying the occurrence of the bus resetting and supplying this signal to the node apparatus on the second network through the bus bridge apparatus.

### CROSS-REFERENCE TO RELATED APPLICATIONS

This application is based upon and claims the benefit of priority from the prior Japanese Patent Application No. 2000-300444, filed Sep. 29, 2000, the entire contents of which are incorporated herein by reference.

### BACKGROUND OF THE INVENTION

The present invention relates to the technique of digital data transfer through a network and, in particular, to performing processing involved upon the occurrence of bus resetting.

In recent times, a high-speed multi-function data transmission technique using a digital transmission via a network has been quickly accepted in the data transmission art. Such data transfer is indispensable to its systematization and its high functioning, but, since the data (contents) flowing on a transmission path is very easier to illegally alter and reproduce than the analog data, it is necessary to provide a protection technique for protecting its contents. As one standardized technique for this purpose there is, for example, a DTCP (Digital Transmission Content Protection) standard-reference is invited to http://www.dtcp.com. This is the technique developed to protect digital synchronization type packet data which flows on the IEEE1394 high-speed serial bus from being altered or illegally reproduced and its specification is laid open to the public at the above-mentioned URL. This DTCP standard has already been used upon transmitting/receiving data between the digital television and the digital VHS.

The DTCP standard is used in data transmission not only on the IEEE1394 high-speed serial bus but also on another bus such as a USB (Universal Serial Bus) bus and is now expanding its use as a standard under which data transmission is made across different buses.

The authentication processing represented by such DTCP processing is such that, in the case of performing DTCP processing between the nodes on different buses, it is done via a DTCP bridge through which these different buses are connected. Jpn. Pat. Appln. KOKAI Publication No. 11-68884 discloses an example of performing signal processing between apparatuses on different buses with the use of such a bridge apparatus and performing such processing via the bridge apparatus through which signals are handled.

In the case where “bus resetting” occurs on one bus (first bus) during the authentication of the DTCP processing in a network connected to a DTCP bus bridge via which the DTCP processing is performed directly between the node apparatuses on different buses, the apparatus connected to the first bus restarts the DTCP processing from the outset on the basis of the DTCP standard. Since, on the other hand, the apparatus connected to the bus (second bus) not involving “bus resetting” does not detect the occurrence of the bus resetting, it tries to continue the DTCP processing. Since, in this case, the apparatus A on the first bus tries to restart the DTCP processing from the outset while, on the other hand, the apparatus B tries to continue the DTCP processing, there occurs a process mismatching between the apparatus A and the apparatus B and, in this case, the DTCP processing becomes unsuccessful.

### BRIEF SUMMARY OF THE INVENTION

It is accordingly to object of the present invention to provide a network communication apparatus and bus bridge apparatus which, when authentication processing is performed via the bus bridge apparatus, can do it stably even if bus resetting occurs.

In order to achieve the above-mentioned object of the present invention there is provided a network communication apparatus which can be detachably connected to a network during an operation, comprising transfer processing means for allowing digital data to be transferred to a node apparatus on a second network via a bus bridge apparatus through which a first network having the network communication apparatus connected thereto and the second network are connected; and notifying means for, when bus resetting occurs on the first network, generating a notify signal for notifying the occurrence of the bus resetting and supplying the notify signal at least to the node apparatus on the second network through the bus bridge apparatus.

In the network communication apparatus of the present invention, when the bus resetting occurs on the first network, a corresponding notify signal is generated and supplies it to the node apparatus on the second network. By doing so, even when DTCP processing for example is currently progressed, it is possible to eliminate any inconvenience that one apparatus interrupts current processing while the other associated apparatus continues the processing, and to take a synchronization between both the apparatuses during the processing.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a view showing a digital information apparatus having a network communication function according to the present invention and its one form of network;

FIG. 2 is a view showing a practical digital information apparatus having a network communication function according to the present invention and its one form of network;

FIG. 3 is an explanatory view for explaining DTCP processing performed between different nodes on respective buses via a bus bridge in a network according to the present invention;

FIG. 4 is an explanatory view for explaining DTCP processing between different nodes on respective buses via a plurality of bus bridges in a network according to the present invention;

FIG. 5 is a timing chart showing the steps of performing DTCP processing between different nodes on respective buses via a bus bridge in a network according to the present invention;

FIG. 6 is a timing chart showing the steps of performing DTCP processing between different nodes on respective buses via a bus bridge in a network according to the present invention;

FIG. 7 is a timing chart showing the steps of performing DTCP processing between different nodes on respective buses via a bus bridge in a network according to the present invention;

FIG. 8 is a flow chart showing the generation of a bus reset notify signal corresponding to the occurrence of bus resetting in a network according to the present invention;

FIG. 9 is a flow chart showing processing performed upon receipt of a bus reset signal in a network according to the present invention; and

FIG. 10 is a block diagram showing one form of a bus bridge apparatus usable in a network according to the present invention.

### DETAILED DESCRIPTION OF THE INVENTION

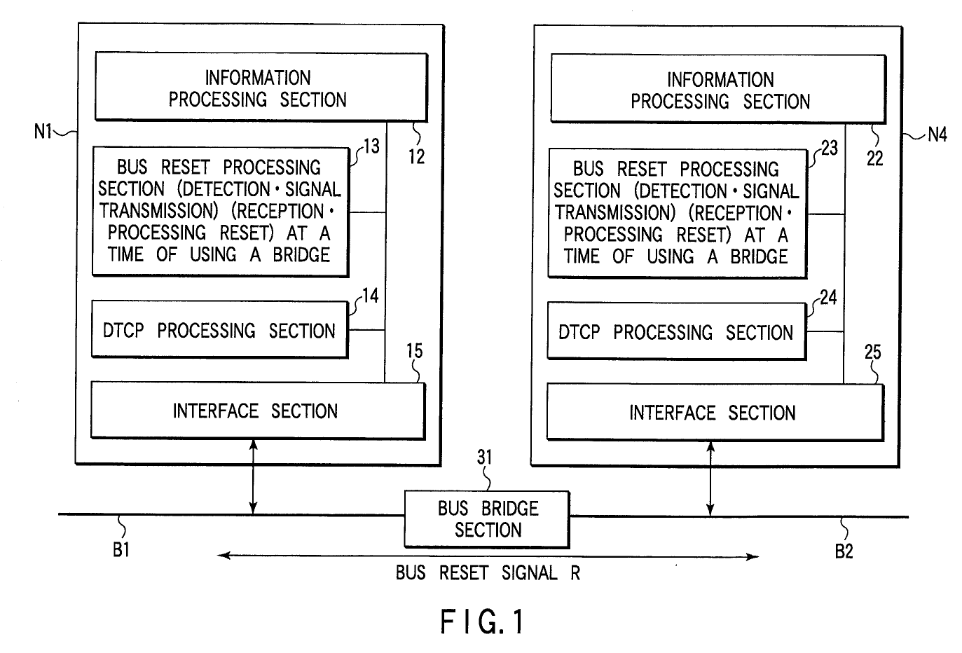

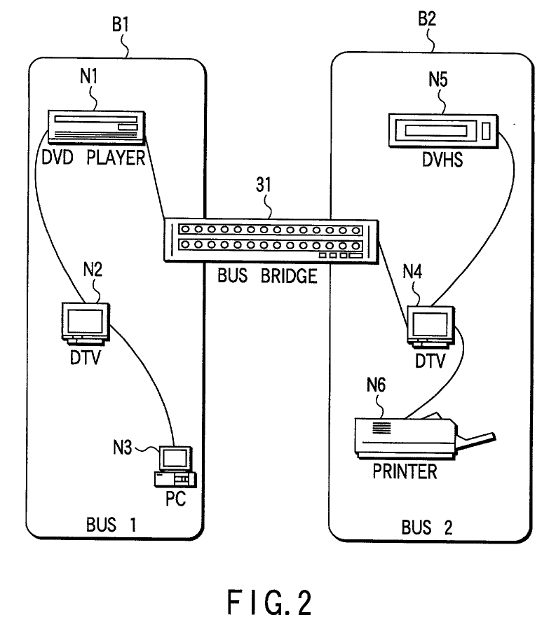

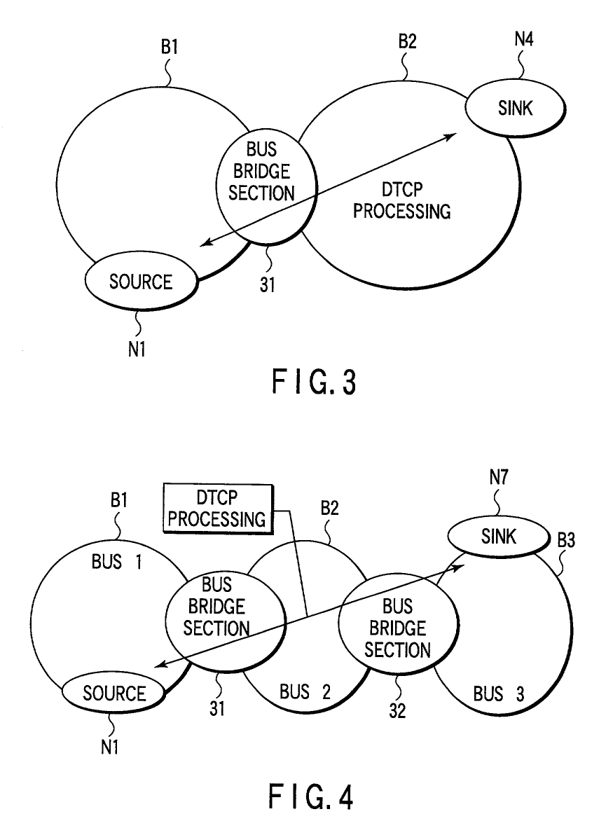

One embodiment of the present invention will be described in more detail below with reference to the accompanying drawings. FIG. 1 is a view showing a digital information apparatus having a network communication function according to the present invention and a practical network using this apparatus and FIG. 2 is a view showing a practical digital information apparatus and its one form of network. FIG. 3 is an explanatory diagram for performing DTCP processing between different nodes on respective buses via a bus bridge in the network according to the present invention and FIG. 4 is an explanatory view for performing DTCP processing between different nodes on respective buses via a plurality of bus bridges.

<Network Apparatus According to the Present Invention>

The digital information apparatus having a network communication function according to the present invention, if it relates to a system handling image data for example, involves various units such as a DVD player, digital television, personal computer, digital video tape recorder and printer, but the present invention is not restricted thereto and various cases may be considered in accordance with a protocol under which the system is connected. In FIG. 1, a digital information apparatus N1 having a network communication function includes and information processing section 12 for performing processing in inherent digital data, such as a data processing section, etc., for performing processing on digital data read by a disk reading mechanism from a disk as in the case of a DVD player, a bus reset processing section 13 as in the case of using a bridge apparatus constituting the feature of the present invention, a DTCP processing section 14 and an interface 15. Further, the digital information apparatus N1 is connected to a first digital bus B1 and also to a bus bridge apparatus 31 via which a plurality of buses are connected.

A digital information apparatus N4 has a network communication function connected to a second digital bus B2 via the bus bridge apparatus 31 and includes, as in the case of the digital information apparatus N1, an information processing section 22 for performing processing on inherent digital data, a bus reset processing section 23 connected to the information processing section 22 as in the case of using a bridge apparatus, a DTCP processing section 24 and an interface 25.

FIG. 2 shows one form of system configuration with a plurality of buses B1, B2 connected together via a bus bridge apparatus 31 and, if this is a system based on image data for example, it may be considered for example that, in a first bus B1, each node apparatus includes a DVD player N1, digital television N2, personal computer N3, etc., and, in a second bus B2, a digital television N4, a digital video tape recorder N5, a printer N6, etc. The respective node apparatus have their interfaces 15, 25 provided under a protocol of the IEEE1394 as one example and, even at an operation time, a detachable connection can be made between the respective node apparatuses and it is possible to readily transfer digital data. Further, by providing the bus bridge 31, there is no upper limit in the number of node apparatuses connectable to one bus under the IEEE1394 protocol and authentication processing and data transfer processing can be performed between node apparatuses on different buses, that is, between the DVD player N1 and the digital television N4.

In the case where the authentication processing, such as the DTCP processing, is performed in a network apparatus having a plurality of buses connected via the bus bridge apparatus shown in FIGS. 1 and 2, it is as shown in FIG. 3 and direct DTCP processing is carried out between the apparatuses on different 1394 buses. It is to be noted that an apparatus N1 on the 1394 bus B1 serves as a source (content transmitting side) and an apparatus N4 on the 1394 bus B2 serves as a sink (content receiving side).

The number of buses involved is not always two and, as shown in FIG. 4, three or more buses are involved under a plurality of bus bridges 31, 32 via which it is possible to perform communication processing as in the case of the node apparatus N7.

In the case of a system having a plurality of bus bridge apparatuses, if bus resetting occurs, a correspondingly generated bus reset notify signal may be transmitted directly to the node apparatus N7 serving as another communication party and is preferably transmitted to a bus bridge apparatus 32 connected to that node apparatus.

<Practical Steps of DTCP Processing According to the Present Invention>

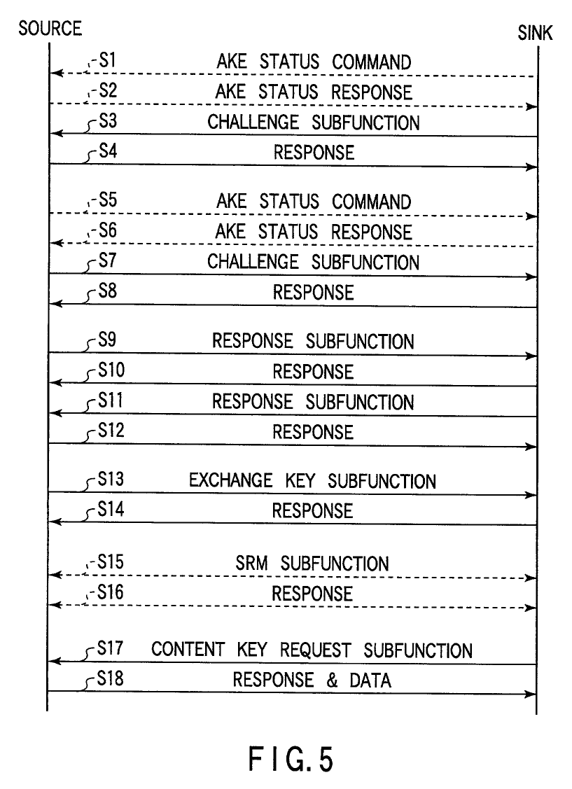

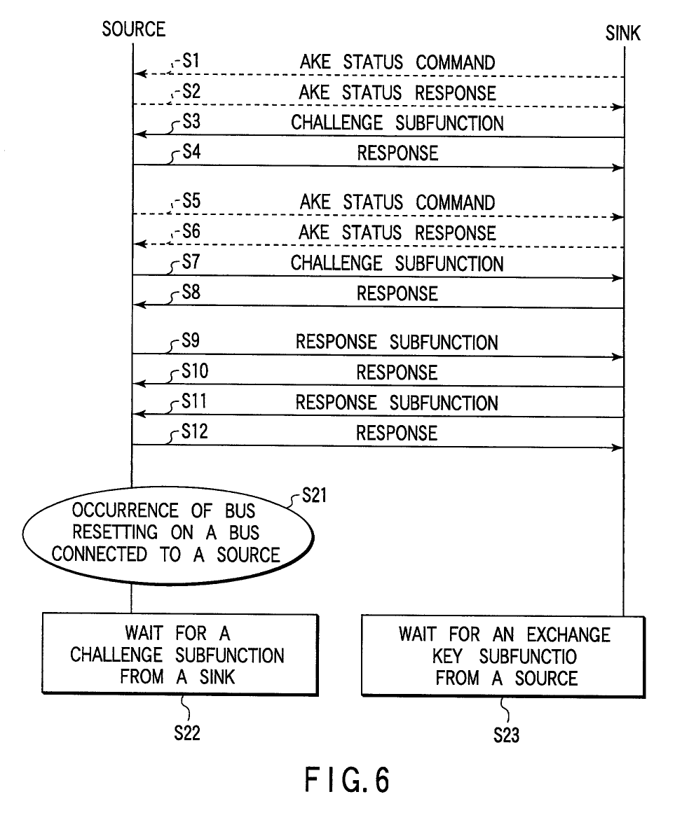

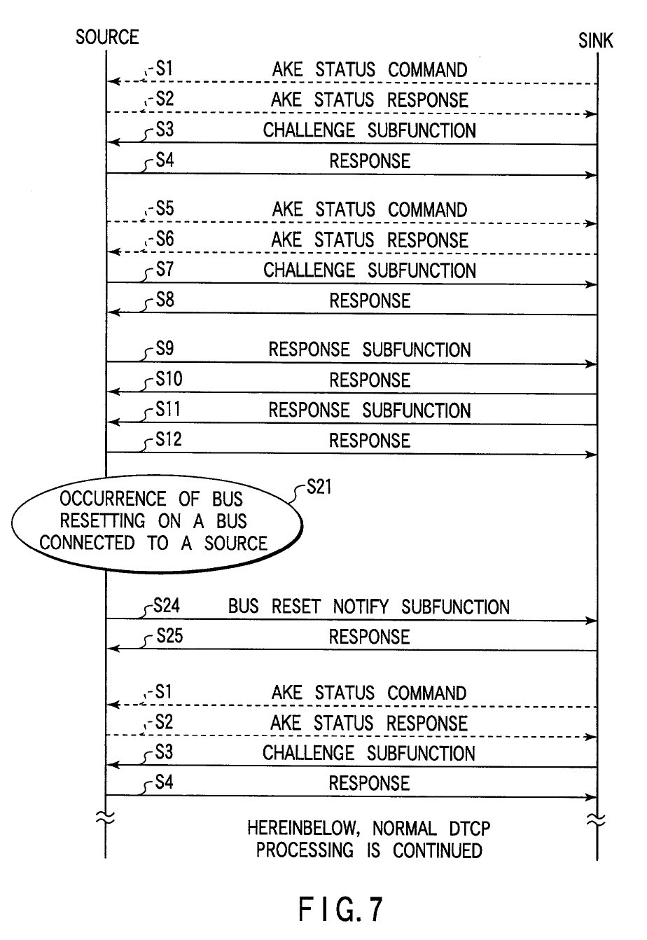

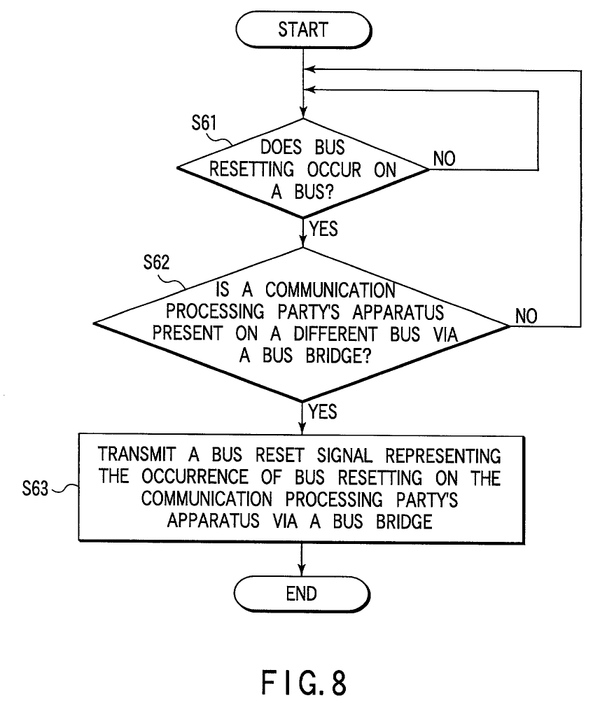

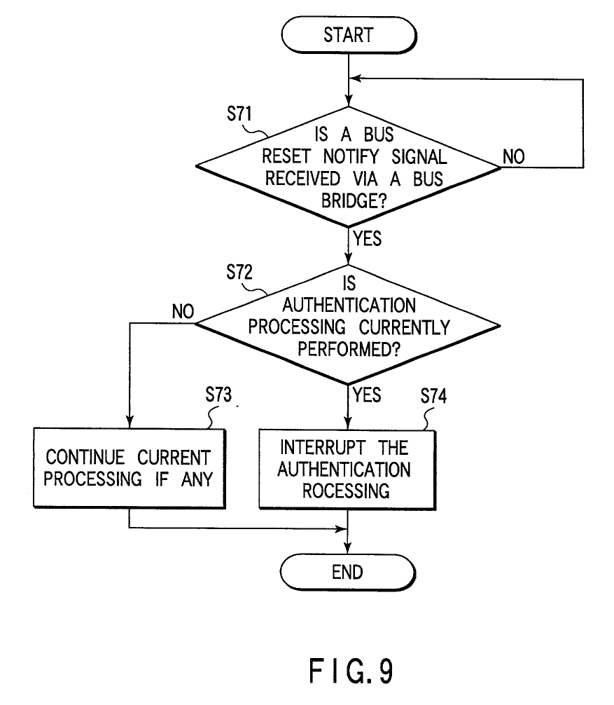

In the network system thus configured, the operation of the network communication apparatus of the present invention will be explained in more detail below with the use of a timing chart and flow chart. FIG. 5 is a timing chart showing the steps of the DTCP processing between different nodes on respective buses connected via the bus bridge, FIG. 6 is a timing chart showing the steps of performing the DTCP processing between different nodes on the respective buses connected via the bus bridge, and FIG. 7 is a timing chart showing the steps of performing the DTCP processing between different nodes on the respective buses connected via the bus bridge. Further, FIG. 8 is a flow chart showing the generation of the bus reset notify signal in accordance with the occurrence of the bus resetting and FIG. 9 is a flow chart showing the processing involved upon receipt of a bus reset notify signal.

In the case where, between the different 1394 buses B1 and B2 as shown in FIG. 3, apparatus authentication under copy protection—hereinafter referred to as an AKE (Authentication Key Exchange)—such as the DTCP processing is performed directly between the nodes N1 and N4, the normal process is as indicated in the timing chart shown in FIG. 5. It is to be noted that FIG. 5 is the timing chart in the case where there arises no bus resetting.

That is, the following processing is performed by the operation of the bus reset processing section 13, DTCP processing section 14 and interface 15 at the source-side node apparatus N1 at the time of using the bridge and the operation of the bus reset processing section 23, DTCP processing section 24 and interface 25 at the sink-side node apparatus N4 at the time of using the bridge. That is, from the sink-side node apparatus N4, an AKE status command is transferred to the source-side node apparatus N1 (S1) and an AKE status response is transferred from the node apparatus N1 (S2) to the sink-side node apparatus. Then a challenge subfunction is transferred from the node apparatus N4 (S3) and a response is transferred from the node apparatus N1 to the node apparatus N4 (S4). Then an AKE status command is transferred from the node apparatus 1 to the node apparatus N4 (S5) and an AKE status response is transferred from the node apparatus N4 to the node apparatus N1 (S6). Then a challenge subfunction is transferred from the node apparatus N1 to the node apparatus N4 (S7) and a response is transferred from the node N4 (S8). Then a response subfunction is transferred from the apparatus node N1 to the apparatus node N4 (S9) and a response is transferred from the node apparatus N4 (S10) and, further, a response subfunction is transferred from the node N4 (S11). Then a response is transferred from the node apparatus N1 (S12) and, further, an exchange subfunction is transferred from the node apparatus N1 (S13) and, from the node apparatus N4, a response is transferred (S14) and an SRM subfunction is transferred (S15) and a response is transferred (S16). Further, from the node apparatus 14, a content key request subfunction is transferred (S17) and, from the node apparatus N1, a response and data are transferred (S18).

Although such normal DTCP processing is performed in a process such as steps S1 to S18, if bus resetting occurs at the source-side bus B1 as shown in FIG. 6 (S21), then it follows that, unless later-described processing constituting the feature of the present invention is performed, no further process goes in such a state that the source side waits for a challenge subfunction from the sink side (S22) and the sink side waits for an exchange key subfunction from the source side. As a result, time-out occurs at the sink side after a time set under the DTCP standard.

The processing at the time-out at the sink site is outside the range of the standard and, if the sink site transmits the challenge subfunction to the source site and the DTCP processing is restarted, then the DTCP processing becomes successful. In this case, since the DTCP processing is not quickly finished, it takes some time to recover the contents at the sink site and it may be considered that, in some case, the contents are not recovered in a due recovery time and the sink-side system halts its recover operation.

In the case where time-out occurs at the sink site, if the specification is such that the sink site does not resume the DTCP processing, then the DTCP processing becomes unsuccessful and no contents are recovered and recorded at the sink site. Therefore, there is a risk that the user cannot see, hear and record/reserve now receiving contents due to the occurring of bus resetting on another bus.

In order to avoid such an inconvenience, processing as indicated by a timing chart of FIG. 7 is performed on the embodiment according to the present invention. That is, when bus resetting occurs on a 1394 bus B1 during authentication processing and the occurrence of the bus resetting is detected (S61) in accordance with the flow chart shown in FIG. 8, if a node apparatus of an authentication processing's party is situated on a different bus via the bus bridge (S62), a bus reset signal R representing the occurrence of the bus resetting at the node apparatus N4 of the communication processing's party is generated and it is transmitted to the node apparatus of the authentication processing's party (S63). It is also preferable to, at this time, transfer it to all node apparatuses on that party-side bus.

Further, the bus reset signal R defines a new AKE command (AKE BUS RESET NOTIFY subfunction command) and it is preferably used as indicated in a timing chart shown in FIG. 7 (S24).

In accordance with the flow chart shown in FIG. 9, the bus reset processing section 23 of the sink-side node apparatus N4, upon receipt of the bus reset signal R via the bus bridge 31 (S71), judges whether or not any authentication processing such as the DTCP processing, etc., is performed (S72). If YES, it cancels a subsequent command signal so as to interrupt the authentication processing. If the authentication processing is not performed and any other processing is performed, it is continued (S73).

By doing so, the sink-side node apparatus N4 receiving the bus reset notice returns a response signal to the source site (S25) and, after this, authentication processing, that is, AKE operation, is restarted from the outset. That is, in accordance with the timing chart of FIG. 7, an AKE status command is transferred (S1) and the authentication processing is restarted from the outset.

According to the embodiment of the present invention, in the case where the authentication processing, that is, AKE operation, is performed by passing the AKE command directly to and from the node on the different 1394 bus, if bus resetting occurs on one 1394 bus during the AKE operation, it is possible to notify the bus resetting to the other node. Even if bus resetting occurs on the one 1394 bus during the apparatus authentication under copy protection, it is possible to avoid any inconvenience that a deadlock state is involved until there occurs a time-out.

<Another Embodiment According to the Present Invention>

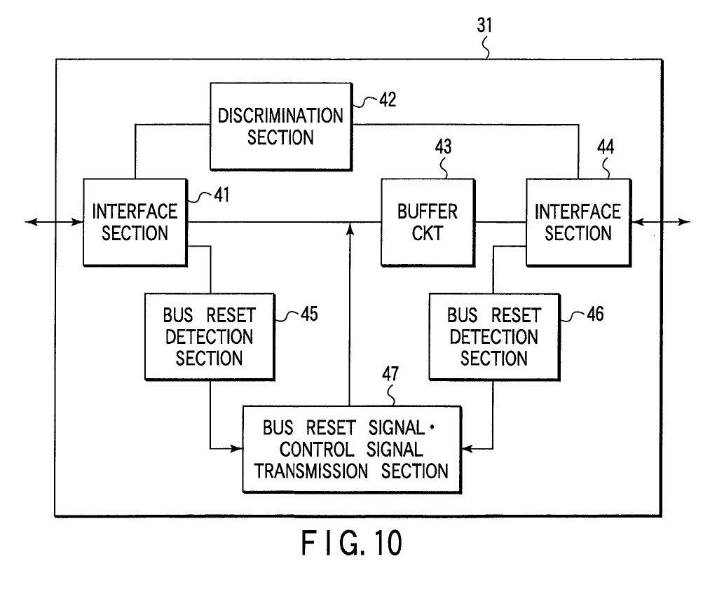

Although, in the above-mentioned embodiment, the bus resetting is notified to an another party's side bus by the DTCP processing node apparatuses N1 to N7 (FIG. 8) and the DTCP interrupt processing is judged (FIG. 9), the DTCP bus bridges 31 and 32 can notify the occurrence of the bus resetting. FIG. 10 shows an arrangement of a bus bridge apparatus 31 in such a case. In FIG. 10, the bus bridge apparatus 31 has an interface 41 and discrimination section 42 on one bus, a buffer circuit 43, and an interface 41 on the other bus and further has two bus reset detection sections 45, 46 each detecting “bus resetting” on the corresponding bus and a bus reset signal•control signal transmitting section 47 for outputting a bus reset signal R, a control signal, etc., for instructing an authentication processing interruption, etc. By the arrangement, the DTCP bus bridge, if authentication processing is started relative to the apparatus on a different 1394 bus, monitors it and, if bus resetting occurs on the 1394 bus Bi during the authentication processing, notifies this to a given apparatus B on the 1394 bus B2 as shown in the flow chart shown in FIG. 8. As shown in the flow chart in FIG. 9, the DTCP bus bridge judges whether or not any authentication processing is performed and transfers a corresponding control signal to respective node apparatuses.

Although, in the above-mentioned embodiment, use is made of a new AKE notify command which notifies the occurrence of “bus resetting” if this occurs, it is also possible to use an existent AKE command and, by doing so, to obtain the same effect. This is the method which, if bus resetting occurs, uses an AKE CANCEL subfunction command (CANCEL subfunction command). In this case, a method is considered by which, if bus resetting occurs, 1 is set to the MSB of an operand [4] of the AKE CANCEL subfunction command.

Although, in the above-mentioned embodiment, an explanation has been made about the apparatus on the 1394 bus, it is needless to say that the same result can be obtained even in another network. It is possible to apply the present invention to the network of, for example, the USB and Bluetooth.

Although, in the above-mentioned embodiment, an explanation has been made about the DTCP processing, it is possible to obtain the same effect in other authentication processing such as authentication processing using, for example, a key.

In the case where, according to the present invention, as set out above, bus resetting occurs relative to the apparatus on one different bus via the bus bridge apparatus during the apparatus authentication under copy protection, the occurrence of the bus resetting is notified to the other node apparatus and, by doing so, it is possible to quickly and positively continue the DTCP processing.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A network communication apparatus which can be detachably connected to a network during an operation, comprising:
transfer processing means for allowing digital data to be transferred to a node apparatus on a second network via a bus bridge apparatus through which a first network having the network communication apparatus connected thereto and the second network are connected; and
notifying means for, when bus resetting occurs on the first network, generating a notify signal for notifying the occurrence of the bus resetting and supplying the notify signal at least to the node apparatus on the second network through the bus bridge apparatus.

2. A network communication apparatus according to claim 1, wherein the notifying means includes:
judging means for judging whether or not the network communication apparatus performs authentication processing relative to the node apparatus connected to the second network; and
supplying means which, when the judging means judges that the network communication apparatus performs authentication processing relative to the node apparatus, if the bus resetting occurs on the first network, generates the notify signal for notifying the occurrence of the bus resetting and supplies the notify signal at least to the node apparatus on the second network through the bus bridge apparatus.

3. A network communication apparatus according to claim 1, further comprising:
receiving means for receiving the notify signal for notifying the occurrence of the bus resetting on the second network;
judging means for, when the receiving means receives the notify signal, judging whether or not the network communication apparatus performs authentication processing relative to the node apparatus connected to the second network; and
interrupting means for, when the judging means judges that the network communication apparatus performs authentication processing relative to the node apparatus, interrupting the authentication processing.

4. A network communication apparatus according to claim 2, wherein the authentication processing is the other party's apparatus authentication processing using a key.

5. A network communication apparatus according to claim 1, wherein the network is comprised of a network under the IEEE1394 protocol.

6. A network communication apparatus according to claim 1, wherein the network is comprised of a network under the USB (Universal Serial Bus) protocol.

7. A bridge apparatus which involves a plurality of networks connected to a network communication apparatus and through which a communication is conducted between the plurality of networks, comprising:
transmitting/receiving means for receiving a signal from a first node apparatus connected to a first network connected to the bridge apparatus and transmitting the signal to a second node apparatus connected to a second network different from the first network and further receiving a signal from the second node apparatus of the second network and transmitting the signal to the first node apparatus of the first network; and
control signal transmitting means which, when bus resetting occurs at one of the first network and second network, if the node apparatus connected to the other network performs authentication processing, generates a control signal for interrupting this processing and transmits the control signal to the node apparatus connected to said other network.

8. A bridge apparatus according to claim 7, wherein the control signal transmitting means includes control signal transmitting means which, when a notify signal showing that the bus resetting occurs at said one network is received, if the node apparatus connected to said other network performs authentication processing, generates a control signal for interrupting this processing and transmits this signal to the node apparatus connected to said other network.

9. A bridge apparatus according to claim 7, further comprising:
transmitting/receiving means for transmitting and receiving a signal between the first node apparatus connected to the first network connected to the bridge apparatus and a third node apparatus provided on a third network connected to a second bridge apparatus connected to the second network different from the first network; and
control signal transmitting means for, when bus resetting occurs on the first network, generating a notify signal for notifying the occurrence of the bus resetting and transmitting this signal to the second bridge apparatus.

10. A bridge apparatus according to claim 7, wherein the authentication processing is comprised of the other party's apparatus authentication processing using a key.

11. A bridge apparatus according to claim 7, wherein the network is comprised of a network under the IEEE1394 protocol.

12. A bridge apparatus according to claim 7, wherein the network is comprised of a network under the USB (Universal Serial Bus) protocol.

13. A network communication method which uses a network communication apparatus to be detachably connected to a network, comprising:
a transfer processing step for performing digital data transferring process between a network communication apparatus on a first network and a node apparatus on a second network by using a bus bridge apparatus connected to the first network and the second network; and
a notifying step for, when bus resetting occurs on the first network, generating a notify signal for notifying the occurrence of the bus resetting and supplying the notify signal at least to the node apparatus on the second network through the bus bridge apparatus.

14. A bridge communication method using a bridge apparatus, connected to a plurality of networks connecting to a network communication apparatus, which performing mediation between the plurality of networks, comprising:
transmitting/receiving step for receiving a signal from a first node apparatus connected to a first network connected to the bridge apparatus and transmitting the signal to a second node apparatus connected to a second network different from the first network and further receiving a signal from the second node apparatus of the second network and transmitting the signal to the first node apparatus of the first network; and
control signal transmitting step for, when bus resetting occurs at one of the first network and second network and the node apparatus connected to the other network performs authentication processing, generating a control signal for interrupting the authentication processing, by using the bridge apparatus.
